(19) United States
(12) Patent Application Publication
(10) Pub. No.: US 2007/0028064 A1
(43) Pub. Date: Feb. 1, 2007

(54) Method for suspending mirrored writes during large data transfers

(76) Inventors: Gerald F. McBrearty, Austin, TX (US); Johnny M. Shieh, Austin, TX (US)

Correspondence Address: IBM CORP. (CLG);c/o CARDINAL LAW GROUP, 1603 ORRINGTON AVENUE, SUITE 2000, EVANSTON, IL, 60201, US

(21) Appl. No.: 11/191,657

(22) Filed: Jul. 28, 2005

(51) Int. Cl. G06F 12/16

(52) U.S. Cl. 711/162

(57) ABSTRACT

A method for mirroring file data includes receiving a data file and determining whether the data file exceeds a predetermined file size. The method further includes sending a mirror suspend notification to at least one mirrored drive and tracking at least one changed disk block, while maintaining read and write capability for each mirrored drive, based on the determination. In one embodiment, upon completion of writing the data file, which exceeds the predetermined file limit, data is re-synced and mirror suspend function is canceled. A computer readable medium including computer readable code, and a system including means, for accomplishing the method steps, are also disclosed.

### FIELD OF INVENTION

The present invention generally relates to mirrored data systems. More specifically, the invention relates to writing data files in mirrored data systems.

### BACKGROUND OF THE INVENTION

Many data storage solutions utilize ‘mirrored’ data systems such that at least two disk drives contain identical data to minimize lost data in the event of catastrophic failure of one drive. Mirrored data systems allow an operating system to have multiple copies of the same data. Mirrored data systems can be convenient for users because the layer above the mirror (such as the filesystem) need not be aware that the layer is writing to a mirrored logical volume. The filesystem issues a ‘write’ command, and the multiple mirrors, typically, write in parallel until the mirrored data system can return an IODONE comment to the filesystem when all the mirror writes complete.

Such an arrangement provides a high degree of file security, but the need to complete all mirror writes can delay the return of an IODONE comment, especially when writing a relatively large data file to the mirrored system. Experience has shown that writing to a mirrored drive takes more time than writing to a non-mirrored drive. However, some degree of performance degradation may be tolerated to maximize data security. Unfortunately, in some circumstances the performance degradation may be unacceptable. For example, if a mirrored file system hosts an email server, a large data write may result in slow performance of the email server as the relatively small and quick data writes for the email system are interspersed with the large file write. In another example, a large data write may be necessary in a short time span due to anticipated problems. For example, a hurricane approaching a data storage center may result in a preference for rapid data transfer to complete at the acceptable risk of temporary suspension of mirrored writes.

It is therefore a challenge to develop a method to store mirrored data to overcome these, and other, disadvantages.

### SUMMARY OF THE INVENTION

A first embodiment of the invention provides a method for mirroring file data that includes receiving a data file and determining whether the data file exceeds a predetermined file size. The method further includes sending a mirror suspend notification to at least one mirrored drive and tracking at least one changed disk block, while maintaining read and write capability for each mirrored drive, based on the determination.

A second embodiment of the present invention is a computer usable medium including computer readable code for receiving a data file and computer readable code for determining whether the data file exceeds a predetermined file size. The medium further includes computer readable code for sending a mirror suspend notification to at least one mirrored drive and computer readable code for tracking at least one changed disk block, while maintaining read and write capability for each mirrored drive, based on the determination.

A third embodiment of the present invention is a system including means for receiving a data file and means for determining whether the data file exceeds a predetermined file size. The system further includes means for sending a mirror suspend notification to at least one mirrored drive and means for tracking at least one changed disk block, while maintaining read and write capability for each mirrored drive, based on the determination.

The foregoing embodiment and other embodiments, objects, and aspects as well as features and advantages of the present invention will become further apparent from the following detailed description of various embodiments of the present invention. The detailed description and drawings are merely illustrative of the present invention, rather than limiting the scope of the present invention being defined by the appended claims and equivalents thereof.

### BRIEF DESCRIPTION OF THE DRAWINGS

FIG. 1 illustrates one embodiment of a method for mirroring file data in accordance with one aspect of the invention;

FIG. 2 illustrates another embodiment of a method for mirroring file data in accordance with one aspect of the invention;

FIG. 3 illustrates another embodiment of a method for mirroring file data in accordance with one aspect of the invention;

FIG. 4 illustrates an embodiment of a method for receiving a data file in accordance with one aspect of the invention;

FIG. 5 illustrates an embodiment of a method for sending disk block updates in accordance with one aspect of the invention;

FIG. 6 is a schematic illustration of a mirrored file system with an incoming data file in accordance with one aspect of the invention; and

FIG. 7 is a schematic illustration of a mirrored file system with an incoming data file in accordance with another aspect of the invention.

### DETAILED DESCRIPTION OF THE PRESENT INVENTION

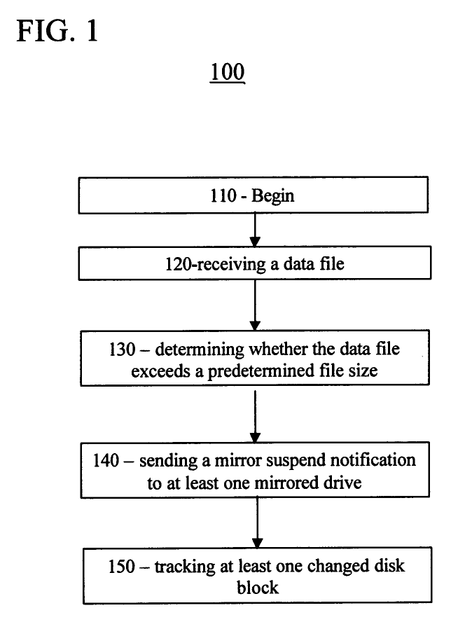

FIG. 1 illustrates one embodiment of a method 100 for mirroring file data in accordance with one aspect of the invention. Method 100 begins at step 110. Any of the inventive methods disclosed herein may be performed in any order, and the order in which the method steps are described does not limit the order in which the steps can be performed.

Method 100 continues at step 120 by receiving a data file. As used herein, the term “data file” is any collection of data bits that collectively records and stores information in digital form. A data file can contain data, information, applications or any information formatted for computer manipulation. The data file is received at a computer file storage system configured for mirroring. In one embodiment, the file storage system in a logical volume mirroring system incorporated as a portion of an operating system.

Having received the data file, method 100 determines whether the data file exceeds a predetermined file size at step 120. The file size can be determined using any appropriate method, including a bitcount, requesting the file size from the source, examining metadata associated with the file, examining a header associated with the file, or other method. The predetermined file size can be a user defined file size, a system administrator determined file size or determined by a manufacturer. The predetermined file size can be edited, in one embodiment, or can remain fixed. The determination is the result of comparing the actual, or an estimated, file size with the predetermined file size. In other embodiments, the predetermined file size is determined based on the size of the mirrored disk. In yet another embodiment, the predetermined file size is determined based on the number of mirrors. In one embodiment, the predetermined file size is one terabyte. In another embodiment, the predetermined file size is 100 gigabytes.

Method 100 sends a mirror suspend notification to at least one mirrored drive based on the file size comparison at step 140. A mirror suspend notification indicates that a mirroring function is to be suspended until the data file is written to one mirrored drive. In one embodiment, the mirror suspend notification is sent in response to the determined file size being greater than the predetermined file size. In another embodiment, the mirror suspend notification is sent in response to other factors, such as the existence of another currently active mirror suspend notification issued by another mirror drive. Another factor, in certain embodiments, is the type of file transfer that is the source of the data file, such as FTP, RCP, CP, or any other known file transfer protocol.

Based on sending the mirror suspend notification, the mirrored system begins tracking each disk block that changes as a result of a read/write command on each mirrored disk, while maintaining the read and write capability for each mirrored drive at step 150. Issuance of the mirror suspend notification results in a different configuration than a ‘snapshot’ configuration, as the mirrored drive remains available for read and write. The tracking of each disk block that changes as a result of a read/write command is implemented using any appropriate technique, including a database.

In one embodiment, sending a mirror suspend notification includes sending a notification of the size and target location of the data file, and notifying each one or more of the mirrored drives to reserve space on the drive to accept the data file that will be re-synced and re-mirrored upon completion of its write to the receiving mirrored drive.

Tracking changed disk blocks enables the mirrored file system to then only synchronize changed blocks after the file write is done, and a mirror resume notification is sent.

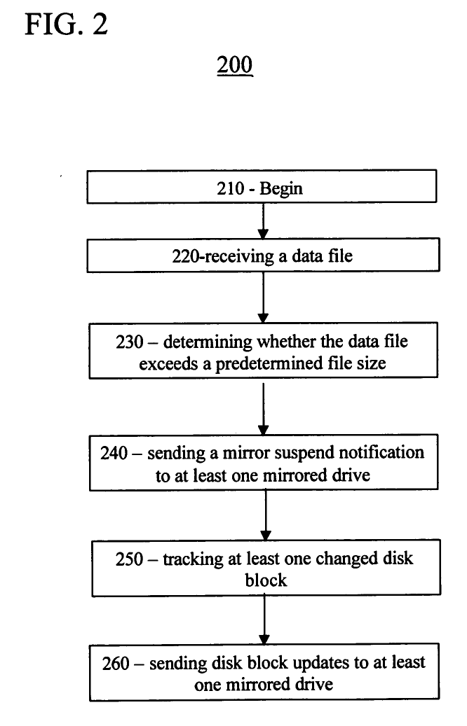

FIG. 2 illustrates another embodiment of a method 200 for mirroring file data in accordance with one aspect of the invention. Method 200 begins at step 210. A data file is received at step 220. In one embodiment, step 220 is implemented as in step 120. Method 200 determines whether the data file exceeds a predetermined file size at step 230. In one embodiment, step 230 is implemented as in step 130. A mirror suspend notification is sent at step 240. In one embodiment, step 240 is implemented as in step 140. At least one changed disk block is tracked at step 250. In one embodiment, step 250 is implemented as in step 150.

Based on the tracked changed blocks, method 100 sends disk block updates to at least one mirrored drive at step 260. Sending the disk block updates provides the mirrored system with the opportunity to update any changes across the mirrored drives. In one embodiment, sending the disk block updates comprises synchronizing the mirrored drives. In the event that there are no tracked disk block changes, no disk block updates need to be sent.

In one embodiment, the disk block updates are sent after the data file is fully written to one mirrored drive. In another embodiment, the disk block updates are sent in the background. In another embodiment, disk block updates are sent using a last-in-first-out priority scheme, while in other embodiments, disk block updates are sent using a first-in-first-out priority scheme.

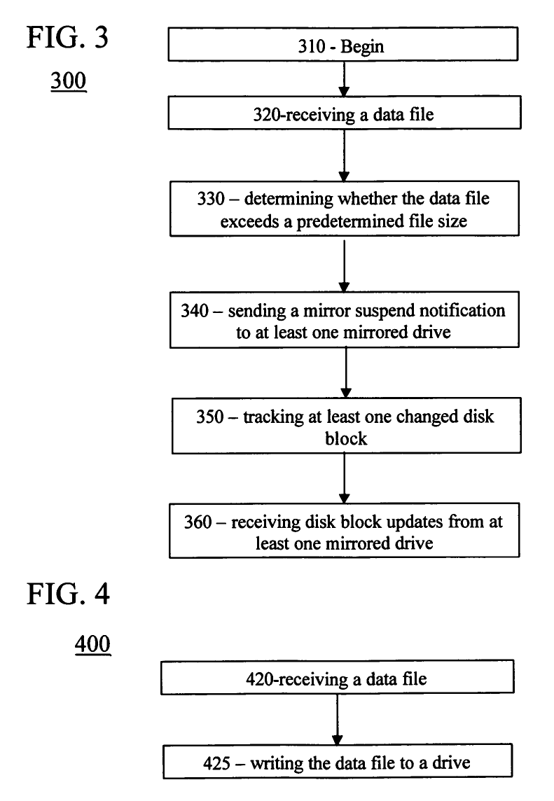

FIG. 3 illustrates another embodiment of a method 300 for mirroring file data in accordance with one aspect of the invention. Method 300 begins at step 310. A data file is received at step 320. In one embodiment, step 320 is implemented as in step 120. Method 300 determines whether the data file exceeds a predetermined file size at step 330. In one embodiment, step 330 is implemented as in step 130. A mirror suspend notification is sent at step 340. In one embodiment, step 340 is implemented as in step 140. At least one changed disk block is tracked at step 350. In one embodiment, step 350 is implemented as in step 150.

Based on sending the disk block updates (for example, step 260), method 300 receives disk block updates from at least one mirrored drive at step 360. The mirrored system updates any changes across the mirrored drives based on the received disk block updates. In one embodiment, receiving the disk block updates comprises synchronizing the mirrored drives. In the event that there are no tracked disk block changes, no disk block updates are received.

FIG. 4 illustrates one embodiment of a method for receiving a data file in accordance with the invention. Method 400 begins at 420 by receiving a data file. The data file is written to a mirrored drive at step 425. Those of ordinary skill in the art are aware of techniques to write a file to a mirrored drive, any of which may be used in method 400. In one embodiment, step 425 is not complete until the data file is fully written to the drive. In another embodiment, step 425 is implemented over a span of time during which the data file is written to the drive.

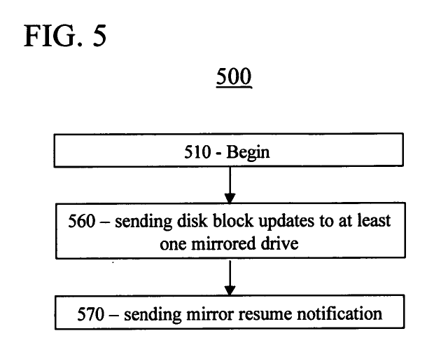

FIG. 5 illustrates one embodiment of a method 500 for sending disk block updates to at least one mirrored drive, in accordance with one aspect of the invention.

Method 500 begins at 560 by sending disk block updates to at least one mirrored drive. Based on sending the disk block updates, method 500 sends a mirror resume notification at step 570. Sending a mirror resume notification results in the mirrored drive file system resuming normal mirror processes such that each drive in a mirrored system contains the same data.

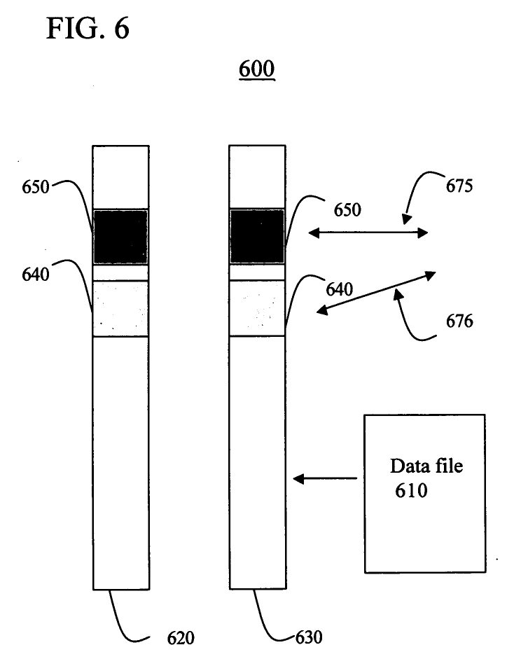

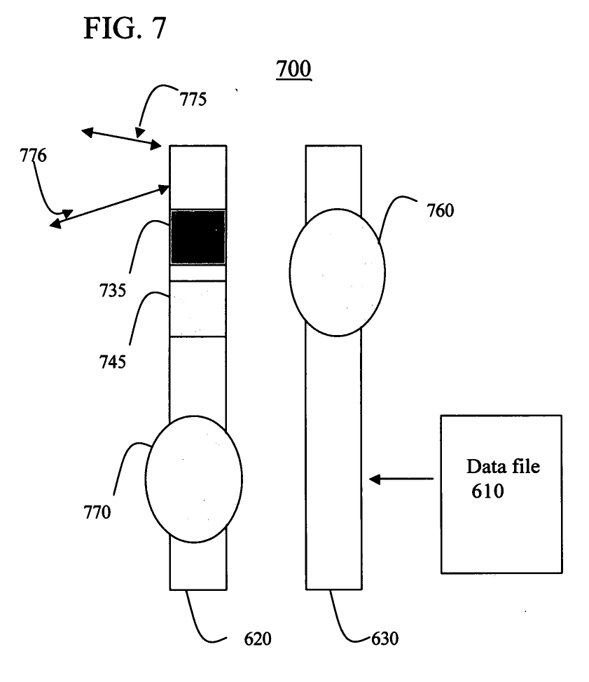

FIGS. 6 and 7 schematically illustrate a mirrored file system with an incoming data file to be written, in accordance with the invention. FIG. 6 illustrates file system 600 including first mirrored drive 620 and second mirrored drive 630. Data file 610 is shown incoming to be written to second mirrored drive 630. For purposes of illustration, the size of data file 610 exceeds the predetermined file size, as per step 130. First and second mirrored drives 620, 630 are in communication with each other (not graphically shown). Additionally, first and second data blocks 640, 650 are maintained on each of first and second mirrored drives 620, 630. First and second read/write requests 675, 676 are illustrated contacting second mirrored drive 630.

FIG. 7 illustrates a mirrored file system with an incoming data file to be written, in accordance with the invention. FIG. 7 continues to show first and second mirrored drives 620, 630, but now the write of data file 610 has resulted in a blocked area 760 on second mirrored drive 630. The blocked area 760 represents the temporarily un-mirrored data of 735 and 745 on 630 that cannot accept mirrored write requests while 610 is being written to 630. In parallel to blocked area 760, there is a ‘frozen’ section 770 on first mirrored drive 620. Any write requests to the frozen area 770 of first mirrored drive 620 is not processed and delayed until the write of data file 610 completes on 630. Once the write of data file 610 onto second mirrored drive 630 is complete and the data file 610 is mirrored onto the frozen section 770 of first mirrored drive 620 then the delayed writes originally meant for frozen section 770 can proceed to first and second mirrored drive 620, 630.

In one embodiment, the methods described herein can be referenced as making first mirrored drive 620 a snapshot of the existing data, while second mirrored drive 630 is a snapshot of the incoming data file 610.

While the embodiments of the present invention disclosed herein are presently considered to be preferred embodiments, various changes and modifications can be made without departing from the spirit and scope of the present invention. The scope of the invention is indicated in the appended claims, and all changes that come within the meaning and range of equivalents are intended to be embraced therein.

We claim:

1. A method for mirroring file data, the method comprising:
receiving a data file;
determining whether the data file exceeds a predetermined file size;
sending a mirror suspend notification to at least one mirrored drive and tracking at least one changed disk block, while maintaining read and write capability for each mirrored drive, based on the determination if the determined data file exceeds the predetermined file size.

2. The method of claim 1 further comprising:
sending disk block updates to at least one mirrored drive.

3. The method of claim 2 further comprising:
receiving disk block updates from the at least one mirrored drive responsive to the sent disk block updates.

4. The method of claim 2 wherein receiving a data file comprises writing the data file to a drive.

5. The method of claim 4 further comprising:
sending a mirror resume notification based on a completion of the data file write.

6. The method of claim 4 further comprising:
synchronizing each mirrored drive after the data file is written to the drive.

7. The method of claim 1 wherein a user determines the predetermined file size.

8. A computer usable medium including computer readable code for mirroring file data, the medium comprising:
computer readable code for receiving a data file;
computer readable code for determining whether the data file exceeds a predetermined file size;
computer readable code for sending a mirror suspend notification to at least one mirrored drive; and
computer readable code for tracking at least one changed disk block, while maintaining read and write capability for each mirrored drive, based on the determination if the determined data file exceeds the predetermined file size.

9. The medium of claim 8 further comprising:
computer readable code for sending disk block updates to at least one mirrored drive.

10. The medium of claim 9 further comprising:
computer readable code for receiving disk block updates from the at least one mirrored drive responsive to the sent disk block updates.

11. The medium of claim 9 wherein computer readable code for receiving a data file comprises computer readable code for writing the data file to a drive.

12. The medium of claim 11 further comprising:
computer readable code for sending a mirror resume notification based on a completion of the data file write.

13. The medium of claim 11 further comprising:
computer readable code for synchronizing each mirrored drive after the data file is written to the drive.

14. The medium of claim 8 wherein a user determines the predetermined file size.

15. A system for mirroring file data, the system comprising:
means for receiving a data file;
means for determining whether the data file exceeds a predetermined file size;
means for sending a mirror suspend notification to at least one mirrored drive; and
means for tracking at least one changed disk block, while maintaining read and write capability for each mirrored drive, based on the determination if the determined data file exceeds the predetermined file size.

16. The system of claim 15 further comprising:
means for sending disk block updates to at least one mirrored drive.

17. The system of claim 15 further comprising:
means for receiving disk block updates from the at least one mirrored drive responsive to the sent disk block updates
